(19) United States
(12) Patent Application Publication
(10) Pub. No.: US 2024/0350999 A1
(43) Pub. Date: Oct. 24, 2024

(54) COAXIAL DIELECTRIC BARRIER DISCHARGE PLASMA BIPHASIC MICROREACTOR FOR CONTINUOUS OXIDATIVE PROCESSES

(71) Applicant: University of Delaware, Newark, DE (US)

(72) Inventors: Panagiotis Dimitrakellis, Newark, DE (US); Fabio Cameli, Newark, DE (US); Dionisios G. Vlachos, Newark, DE (US)

(73) Assignee: University of Delaware, Newark, DE (US)

(21) Appl. No.: 18/685,604

(22) PCT Filed: Aug. 23, 2022
(86) PCT No.: PCT/US2022/041174

§ 371 Date: Feb. 22, 2024

Related U.S. Application Data
(60) Provisional application No. 63/236,257, filed on Aug. 24, 2021.

(51) Int. Cl. B01J 19/08; C01B 3/34; C01B 15/027; C02F 1/72; C02F 101/30; C07B 33/00

(52) U.S. Cl. CPC B01J 19/088; C01B 3/342; C01B 15/027; C02F 1/722; C07B 33/00; B01J 2219/0809; B01J 2219/083; B01J 2219/0884; B01J 2219/0896; C01B 2203/0211; C01B 2203/0861; C02F 2101/308

(57) ABSTRACT

A reactor assembly for igniting and sustaining a plasma and method for performing a reaction. The assembly includes an elongated cylindrical inner electrode; a dielectric tube arranged helically around the elongated cylindrical inner electrode to form a helical reactor. The reactor assembly also includes an annular outer electrode arranged around at least a portion of the exterior of the helical reactor. The assembly includes a power source to provide a voltage across the elongated cylindrical inner electrode and the annular outer electrode. A process stream including at least a gas flows through the dielectric tube. The voltage is applied across the elongated cylindrical inner electrode and the annular outer electrode such that at least a portion of the flow of the process stream through the dielectric tube is exposed to the voltage and the plasma is ignited and sustained.

### CROSS REFERENCE TO RELATED APPLICATIONS

This invention claims the benefit of priority of U.S. provisional application No. 63/236,257, filed on Aug. 24, 2021, the entire contents of which is incorporated by reference herein for all purposes.

### STATEMENT REGARDING FEDERALLY SPONSORED RESEARCH

This invention was made with government support under DE-EE0007888-7.6 awarded by the Department of Energy's Office of Energy Efficient and Renewable Energy's Advanced Manufacturing Office. The government has certain rights in the invention.

### FIELD OF INVENTION

The invention relates to a non-thermal atmospheric plasma microreactor and method of use for oxidative reactions.

### BACKGROUND

Dielectric-barrier-discharge (DBD) plasma reactors for liquid treatment have gained significant interest in recent years with many published works presenting new reactor configurations. Nonetheless, few works have focused on optimization of reactor design for enhanced energy efficiency and productivity. The most promising reactor set-ups possess limitations either in the scalability due to inefficient electrode assembly and/or in the flow pattern control which is responsible for the generation of the active species.

A need remains for an energy-efficient, cost effective plasma reactor that is capable of effecting chemical reactions for such processes as hydrogen peroxide production, or oxidative degradation of organic species for water remediation, to name a few suitable applications.

### SUMMARY

The present disclosure provides a reactor and method of use that affords energy efficient production of oxidative species in a tunable fashion. The reactor is capable of performing a number of oxidation processes featuring different liquid and gas streams. Furthermore, the scalable reactor configuration enables varying residence time and flow rates in order to maximize process productivity. Herein, we disclose an innovative dielectric barrier discharge (DBD) plasma microreactor that affords compact geometry with minimal electrode distance alongside a scalable reactor volume. Furthermore, the gas-liquid biphasic mixture fed into the reactor can be properly controlled to match the specific reaction conditions and intensify the production of oxidative species at the gas-liquid interface. This control enables high interfacial area at high gas-to-liquid flow rate and employment of a longer reactor to extend the residence time without changing the plasma configuration.

Due to their high reactivity at mild operating conditions, non-thermal atmospheric plasma reactors can play a major role in the electrification of the chemical industry. Hence, decentralized production of chemicals can be attained with small footprint modular reactors entirely sustained by electric energy. Low input power, and in turn, high energy efficiency can be achieved at low electrode distance in a dielectric barrier discharge plasma reactor. Thus, small reactor volumes are commonly observed for this kind of set-ups with parallelization of several small reactors being the preferred scale-up strategy.

The advantages of at least some embodiments as disclosed herein include one or more of the following:
1) Compact reactor design allows for small electrode distance and low power input.
2) The coaxial tubular reactor can be scaled linearly without affecting the plasma generation.
3) The distribution of the biphasic stream in the tubular reactor can be tuned according to the specific target of the oxidative process of interest.
4) The coaxial configuration is suitable for controlled heating of the inner electrode and consequently of the reactor tube walls. The small tube dimension enables enhanced heat transfer to the flowing mixture.

A reactor assembly for igniting and sustaining a plasma is provided. The apparatus includes an elongated cylindrical inner electrode and a dielectric tube arranged helically around the elongated cylindrical inner electrode to form a helical reactor. The dielectric tube has an inlet end and an outlet end. Also included is an annular outer electrode arranged around at least a portion of the exterior of the helical reactor. The dielectric tube is arranged between the elongated cylindrical inner electrode and the annular outer electrode. The reactor also includes a process stream that comprises at least a gas in flow communication with the inlet end of the dielectric tube. The reactor assembly also has a power source constructed and arranged to provide a voltage across the elongated cylindrical inner electrode and the annular outer electrode. The reactor assembly is constructed and arranged to provide a flow of the process stream comprising at least the gas through the dielectric tube. When the voltage is applied across the elongated cylindrical inner electrode and the annular outer electrode such that at least a portion of the flow of the process stream comprising at least the gas through the dielectric tube is exposed to the voltage, the plasma is ignited and sustained.

A method of performing a reaction is also provided. The method has the steps:
a) Contacting a first feed stream comprising at least a gas with a second feed stream to provide a reaction stream; and
b) applying a voltage across the annular outer electrode and the inner elongated cylindrical electrode to ignite and sustain a plasma in the reaction stream.

The contacting takes place in a dielectric tube arranged helically around an elongated cylindrical inner electrode to form a helical reactor. An annular outer electrode is arranged around at least a portion of the exterior of the helical reactor such that the dielectric tube is between the elongated cylindrical inner electrode and the annular outer electrode. The voltage is sufficient to ignite and sustain the plasma in the reaction stream. The plasma produces a reaction that forms a product stream comprising reaction products. The dielectric tube comprises an inlet end configured and arranged to accept the first feed stream and the second feed stream, and the dielectric tube comprises an outlet end configured and arranged to discharge the product stream.

### BRIEF DESCRIPTION OF THE FIGURES

FIG. 1 shows a schematic of the overall plasma microreactor system setup according to an embodiment of the invention;

FIGS. 2A-2C show parts of the reactor assembly, prior to being assembled, and FIG. 2D shows the parts as assembled;

FIG. 3A shows a side view of art of the coaxial dielectric barrier discharge (DBD) reactor assembly;

FIG. 3B shows a top view of part of the coaxial dielectric barrier discharge (DBD) reactor assembly;

FIG. 3C shows a photograph of plasma ignition in Helium gas inside the helical tubular dielectric reactor;

FIG. 3D shows an image made with an iCCD camera of gas-liquid flow in the tubular microreactor around the inner electrode;

FIG. 4 shows another top view of the part of the reactor assembly;

FIG. 5 shows another top view of the assembled reactor with dimensions;

FIG. 6 shows the flow configuration of the gas and liquid feeds into the T-junction used for computational fluid dynamic (CFD) simulations;

FIG. 7 shows the computational fluid dynamic simulation (CFD) of the liquid slug entrained in the carrier gas as a function gas to liquid flow rate ratios (G:L);

FIG. 8 shows the specific surface area of the liquid slugs at various residence times (CFD) simulation;

FIG. 9 shows (CFD) simulated lengths of the slugs at various liquid flow rates and G:L volumetric flow rate ratios as a function of liquid flow rate;

FIG. 10 shows the residence time of the biphasic mixture at varying G:L ratios as a function of liquid flow rate (from CFD simulation) Electrode length, 12 cm; applied voltage, 8 kV (peak-to-peak);

FIG. 11 shows Specific surface area of the liquid slugs (from CFD analysis) vs. residence time. Electrode length, 12 cm; applied voltage, 8 kV (peak-to-peak);

FIG. 12 shows the effect of outer electrode length on residence time and dissipated power;

FIG. 13 shows the effect of outer electrode length on the hydrogen peroxide concentration and energy yield;

FIG. 14 shows the dissipated power as a function of applied voltage;

FIG. 15 shows the effect of applied voltage on hydrogen peroxide concentration and dissipated power;

FIG. 16 shows H₂O₂ concentration at different G:L volumetric flow rate ratios. Electrode length, 12 cm; applied voltage, 8 kV (peak-to-peak);

FIG. 17 shows H₂O₂ production rate with varying liquid flow rate and at different gas to liquid (G:L) flow rate ratios. Electrode length, 12 cm; applied voltage, 8 kV (peak-to-peak);

FIG. 18 shows the correlation between the production rate and the product of specific surface area and residence time. Electrode length, 12 cm; applied voltage, 8 kV (peak-to-peak);

FIG. 19 shows liquid H₂O₂ production rate at varying concentrations of the ·OH radical scavenger (DMSO) in the aqueous stream for various specific liquid slugs/droplet surface areas. Varying gas flow rates with constant liquid flow rate of 0.2 mL min⁻¹;

FIG. 20 shows H₂ gas production rate at varying concentrations of the ·OH radical scavenger (DMSO) in the aqueous stream for various specific liquid slugs/droplet surface areas. Varying gas flow rates with constant liquid flow rate of 0.2 mL min⁻¹;

FIG. 21 shows variation of H₂O₂ concentration with reactor wall temperature for liquid and gas flow rates of 0.2 and 320 mL min⁻¹ (G:L=1600), respectively. Electrode length, 12 cm; applied voltage, 8 kV (peak-to-peak);

FIG. 22 shows a comparison of He and Ar as the carrier gas for H₂O₂ concentration and dissipated power;

FIG. 23 shows comparison of He and Ar as the carrier gas for H₂O₂ energy yield and H₂ production; and

FIG. 24 shows the decolorization of methylene blue using an embodiment of the invention.

### DETAILED DESCRIPTION

The present invention provides a reactor and process that is capable of producing, inter alia, hydrogen peroxide in a manner that addresses some of the shortfalls of current methods of production. Hydrogen peroxide is regarded as the best “green” oxidant for chemical transformations. Its only byproduct is water, allowing for a waste-free oxidation process. Plasma processes for producing hydrogen peroxide are desirable because they are thought to be more energy efficient and cleaner than alternative processes, but there has yet to be any large-scale implementation of plasma-activated water reactors. The microreactor disclosed herein provides fabrication and operational simplicity, yields a higher concentration of hydrogen peroxide and offers more opportunity for scalability and extension to a variety of oxidative transformations as compared to other methods. The reactor provides a controllable temperature. For example, the production rate at 25° C. can be doubled by heating the reactor wall to 40° C., which may be beneficial for transforming low-volatility compounds). The reactor has a modular design which allows for versatility in a broad range of oxidation reactions. The reactor is capable of a linear scale-up (doubling the length of the reactor doubles its production rate) which enables it to retain its high energy efficiency at larger scales. The reactor can be made at a low cost and is simple to fabricate.

A biphasic plasma microreactor for distributed production of H₂O₂ or other product is provided. The helical tube arrangement in a coaxial dielectric barrier discharge (DBD) configuration affords high reactor modularity with the electrode length being an independent parameter to regulate the residence time, the supplied power, and consequently the H₂O₂ generation. The one-dimensional scale-up strategy does not alter the H₂O₂ energy yield. Hence the reactor can be elongated to match specific process requirements. Furthermore, the outer diameter of the tubular microreactor containing the biphasic (water and helium or water and argon) stream determines the inter-electrode distance. The small electrode gap in the coaxial configuration enables low applied voltages and input power. The system can be run with as low as 4 kV (peak-to-peak) voltage and power of 0.7 W producing an H₂O₂ concentration of 2.2 mM. Conversely, higher voltage and input power yield a higher H₂O₂ concentration (up to 33 mM) without hampering the energy yield. The microreactor possesses a high interfacial area between the gas and liquid phases. CFD calculations shown in the Examples correlate the gas-to-liquid flow rate ratio with the specific surface area of the liquid slugs flowing through the reactor. Analysis of the reactor outlet confirms that intensified H₂O₂ concentrations (>30 mM) are attained at a high interfacial area and low residence times, e.g., 50 ms. Moreover, the reactor temperature could be externally controlled to enhance evaporation and intensify the production rate and energy yield of H₂O₂. The modest reactor footprint owing to the microreactor size and the potential for using renewable electricity make it amenable to a number-up strategy to attain large scale production of H₂0₂. A bundle of coaxial reactors could be utilized similar to those deployed in the industrial ozone generation.

### Apparatus:

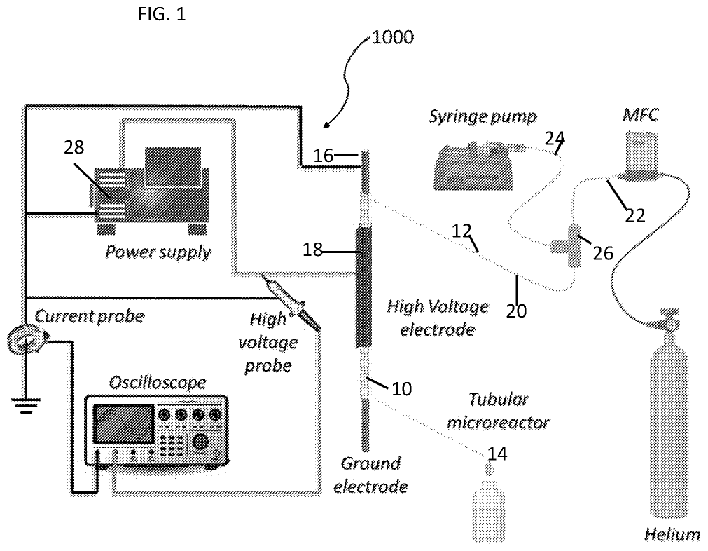

FIGS. 1-5 show an exemplary embodiment of the reactor assembly.

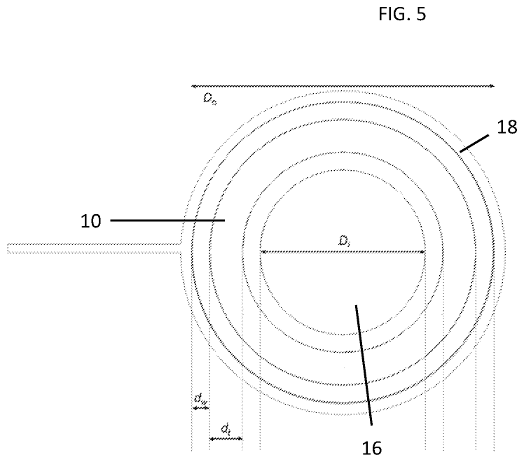

FIG. 1 shows a schematic of a reactor assembly 1000. The reactor assembly 1000 includes an elongated cylindrical inner electrode 16; a dielectric tube arranged helically around the elongated cylindrical inner electrode 16 to form a helical reactor 10. The dielectric tube has an inlet end 12 and an outlet end 14. The reactor assembly 1000 also has an annular outer electrode 18 arranged around at least a portion of the exterior of the helical reactor 10. The helically wound dielectric tube that forms the reactor 10 is arranged between the elongated cylindrical inner electrode 16 and the annular outer electrode 18. Also shown in FIG. 5 is a process stream 20 that includes at least a gas 22 in flow communication with the inlet end 12 of the dielectric tube 10. As shown in FIG. 5, the gas stream may be combined with a liquid stream 24 in a Tee junction 26, before the combined process stream 20 is fed to the reactor 10. A power source 28 is constructed and arranged to provide a voltage across the elongated cylindrical inner electrode 16 and the annular outer electrode 18. The reactor assembly 1000 is constructed and arranged to provide a flow of the process stream 20 including the gas 22 and the liquid 24 through the dielectric tube formed into the helical reactor 10. The voltage is applied across the elongated cylindrical inner electrode 16 and the annular outer electrode 18 such that at least a portion of the flow of the process stream 20 comprising the gas 22 and the liquid 24 through the dielectric tube 10 is exposed to the voltage and the plasma is ignited and sustained.

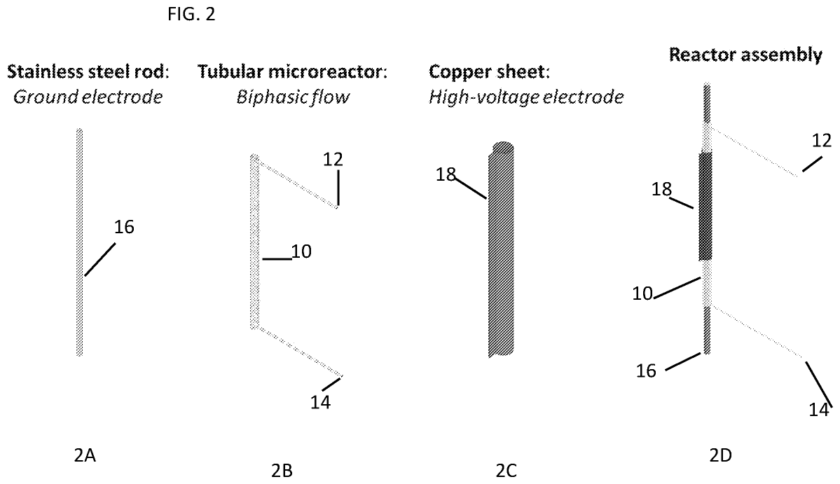

As seen in FIGS. 2A-2D, part of the reactor assembly includes a tubular reactor 10, having an inlet end 12 and an outlet end 14. The tubular reactor 10 is arranged helically around an elongated inner electrode 16, and an annular outer electrode 18 is arranged around the helically wound tubular reactor 10. FIG. 2A shows the elongated inner electrode. FIG. 2B shows the helically wound tubular reactor 10, having the inlet end 12 and the outlet end 14. As shown in FIG. 2B and in FIG. 2D, tubular reactor 10 is desirably wound as closely as possible around the inner electrode 16, such that the outside of the tube contacts itself at each wrap, to provide the most wraps possible around the inner electrode 16. It is desirable, but not required that the tubular reactor 10 also contacts the inner electrode 16 as it is wrapped (or wound) helically. A skilled person will appreciate that the tubular reactor has an inner diameter and an outer diameter. FIG. 2C shows the annular outer electrode 18 and FIG. 2D shows the assembled reactor, including the inner electrode 16, the outer electrode 18 and the helically wound tubular reactor 10 arranged therebetween. As shown in FIG. 1, the process stream enters the inlet end 12 of the tubular reactor 10 and exits the outer end 14 of the tubular reactor 10. As the reaction stream flows through the tubular reactor 10, it is subjected to a voltage that is applied across the inner electrode 16 and the outer electrode 18. The process stream comprises at least a gas phase, and advantageously is a bi-phase stream of both liquid and the gas. The applied voltage is sufficient to ignite and sustain a plasma in the reaction stream.

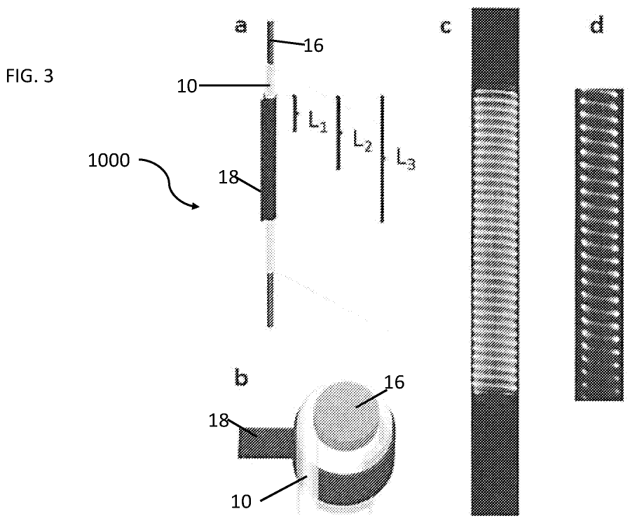

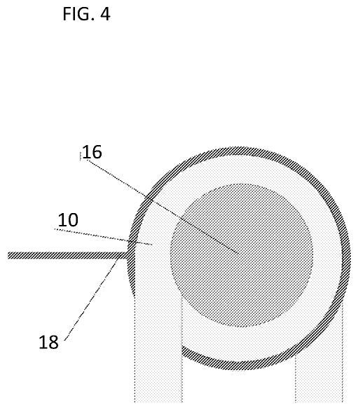

FIGS. 3A-2D show another view of the reactor assembly. FIG. 3A shows schematically that the length L₁, L₂, L₃, etc. of the annular outer electrode 18 may be varied. FIG. 3B shows a top view of the reactor assembly 1000, showing how the tubular reactor 10 is wrapped (or wound) helically around the inner electrode 16 and then the annular outer electrode 18 is arranged over the helically wound tubular reactor. FIG. 3C shows a photograph of plasma ignition in helium gas inside the helical tubular dielectric tubular reactor 10. FIG. 3D shows an image made with an iCCD camera of the reaction gas-liquid flow in the tubular microreactor 10 wound helically around the inner electrode 16. FIG. 4 is a schematic top view of the reactor 10 wrapped (or wound) helically around the inner electrode 16 and then the annular outer electrode 18 is arranged over the helically wound tubular reactor.

FIG. 5 shows another top view of the assembled reactor with dimensions. As shown in the figure, Dₒ is the diameter of the outer electrode 18. Dᵢ is the diameter of the inner electrode 16, d_{w} is the wall thickness of the tubular reactor 10 and dₜ is the inner diameter of the tubular reactor 10. As seen in this figure, the elongated cylindrical inner electrode 16 and the outer annular electrode 18 are coaxial. The helix of the helically wound tubular reactor is coaxial with the elongated cylindrical inner electrode 16 and the outer annular electrode 18. The gap length between the outer electrode and the inner electrode is therefore equal to (Dₒ−Dᵢ)/2. Accordingly, a minimum gap length between the inner electrode 16 and the outer electrode 18 is equal to the outer diameter of the tubular reactor 10 which is 2d_{w}+dₜ.

A reactor assembly for igniting and sustaining a plasma is provided. The reactor assembly comprises the following components:
An elongated cylindrical inner electrode;
a dielectric tube arranged helically around the elongated cylindrical inner electrode to form a helical reactor, the dielectric tube comprising an inlet end and an outlet end;
an annular outer electrode arranged around at least a portion of the exterior of the helical reactor; wherein the dielectric tube is arranged between the elongated cylindrical inner electrode and the annular outer electrode;
a process stream comprising at least a gas in flow communication with the inlet end of the dielectric tube; and
a power source constructed and arranged to provide a voltage across the elongated cylindrical inner electrode and the annular outer electrode.

The reactor assembly is constructed and arranged to provide a flow of the process stream comprising at least the gas through the dielectric tube. When the voltage is applied across the elongated cylindrical inner electrode and the annular outer electrode such that at least a portion of the flow of the process stream comprising at least the gas through the dielectric tube is exposed to the voltage, the plasma is ignited and sustained.

According to an embodiment, the helical reactor contacts the elongated cylindrical inner electrode. According to another embodiment, the helical reactor contacts an inner surface of the annular outer electrode. In another embodiment, a gap having a gap length separates the elongated cylindrical inner electrode and an interior surface of the annular outer electrode, and a ratio of the voltage to the gap length is at least about 1 kV/mm. The ratio of the voltage to the gap length may be from 1 to 3 kV/mm, preferably from 1.5 to 3 kV/mm, more preferably from 2 to 3 kV/mm. For example, the ratio of the voltage may be at least about 1 kV/mm, 1.1, 1.2, 1.3, 1.4, 1.5, 1.6, 1.7, 1.8, 1.9, 2.0, 2.2, 2.4, 2.6, 2.8, 3.0, 3.25, 3.5, 3.75, or at least about 4.0 kV/mm. The gap length separating the elongated cylindrical electrode and the interior surface of the out electrode therefore has a minimum length equal to the outer diameter of the dielectric tube. The gap length may be from 1 to 10 mm, preferably from 1 to 5 mm, more preferably from 1.5 to 3 mm. The gap length may be at least 1.5 mm, 1.6, 1.7, 1.8, 1.9, 2.0, 2.1, 2.2, 2.3, 2.2, 2.3, 2.4, 2.4, 2.6, 2.7, 2.8, 2.9, 3.0, 3.0, 3.1, 3.2, 3.3, 3.4, or at least 3.5 mm. The maximum gap length may be at most 10, 9, 8, 7, 6, 5, or at most 4 mm.

According to an embodiment, the dielectric tube may have an outer diameter of from 1.5 mm to 3.5 mm; and an inner diameter of from 0.75 mm to 1.5 mm. The outer diameter may be from 1.5 to 3.5 mm, preferably from 1.5 to 3 mm, more preferably from 1.5 to 2 mm. The outer diameter of the dielectric tube may be at least 1.5 mm, 1.6, 1.7, 1.8, 1.9, 2.0, 2.1, 2.2, 2.3, 2.2, 2.3, 2.4, 2.4, 2.6, 2.7, 2.8, 2.9, 3.0, 3.0, 3.1, 3.2, 3.3, or at least 3.4 mm. The outer diameter of the dielectric tube may be at most 3.5 mm, 3.4, 3.2, 3.1, 3.0, 2.9, 2.8, 2.7, 2.6, 2.5, 2.4, 2.3, 2.2, 2.1, 2.0, 1.9, 1.8, 1.7, or at most 1.6 mm. The inner diameter of the dielectric tube may be from 0.75 to 1.6 mm, preferably from 0.75 to 1.25 mm, more preferably from 0.75 to 1 mm. The inner diameter of the dielectric tube may be at least 0.75 mm, or 0.80, 0.85, 0.90, 0.95, 1.0, 1.05, 1.10, 1.15, 1.20, 1.25, 1.30, 1.35, 1.40, 1.45, 1.50, or at least 1.55 mm. The inner diameter of the dielectric tube may be at most 1.60, 1.55, 1.50, 1.45, 1.40, 1.35, 1.30, 1.25, 1.20, 1.15, 1.10, 1.05, 1.00, 0.95, 0.90, 0.85, or at most 0.80 mm.

The “unwound” length of the dielectric tube is not particularly limited. For example, the dielectric tube may be 0.5 m long or 1.0, 1.5, 2.0, 2.5, 3.0, 3.5. 4.0, 4.5, 5.5, 6.0 m long, or even longer. Importantly, the dielectric tube is closely wound around the inner electrode, such the maximum possible number of wraps per length is attained. The dielectric tube may be made of any suitable dielectric material. For example, the dielectric tube may comprise at least one of silicon dioxide (silica glass); boron trioxide and silicon dioxide (borosilicate glass); perfluoroalkoxyalkane; polytetrafluoroethylene; or combinations thereof.

According to an embodiment, the elongated cylindrical inner electrode has a diameter of preferably from 4 mm to 20 mm, more preferably from 6 to 15 mm, most preferably from 8 to 12 mm. The elongated inner electrode may be at least 4, 5, 6, 7, 8, 9, 10, 11, 12, 13, 14, 15, 16, 17, 18, 19, or at least 20 mm in diameter. The elongated inner electrode may be at most 20, 19, 18, 17, 16, 15, 14, 13, 12, 11, 10, 9, 8, 7, 6, 5, or at most 4 mm in diameter. The length of the elongated inner electrode is not particularly limited. The residence time of the process stream in the applied voltage is related to the length of the inner and outer electrodes. Longer inner and outer electrodes provide a longer residence time of the process stream in the applied voltage. For example, the inner electrode may be at least 10 cm, 11, 12, 15, 20, 25, 30, 35, 40, 45, 50, 55, 60, 65, 70, 75, 80, 85, 90 cm, or 1 m or even longer in length. The elongated cylindrical inner electrode may be made of any suitable electrically conductive material. For example, the elongated cylindrical inner electrode may comprise at least one of stainless steel, steel, aluminum, copper, or combinations thereof.

Like the elongated cylindrical inner electrode, the length of the outer annular electrode is not particularly limited. It should be either the same length as the elongated cylindrical inner electrode or be shorter. For example, the annular outer electrode may be at least 10 cm, 11, 12, 15, 20, 25, 30, 35, 40, 45, 50, 55, 60, 65, 70, 75, 80, 85, 90 cm, or 1 m or even longer in length. The annular outer electrode may be made of any suitable electrically conductive material. For example, the annular outer electrode may comprise at least one of stainless steel, steel, aluminum, copper, or combinations thereof.

The power source may supply a pulsed voltage between the elongated cylindrical inner electrode and the annular outer electrode. According to an embodiment, the power source may supply a D.C. voltage between the elongated cylindrical inner electrode and the annular outer electrode. According to an embodiment, the power source supplies an A.C. current between the elongated cylindrical inner electrode and the annular outer electrode.

### Method:

A method of performing a reaction is also provided. The method includes the steps a) and b).

Step a) is contacting a first feed stream comprising at least a gas with a second feed stream to provide a reaction stream. The contacting takes place in the dielectric tube arranged helically around an elongated cylindrical inner electrode to form a helical reactor. An annular outer electrode is arranged around at least a portion of the exterior of the helical reactor such that the dielectric tube is between the elongated cylindrical inner electrode and the annular outer electrode.

Step b) is applying a voltage across the annular outer electrode and the inner elongated cylindrical electrode to ignite and sustain a plasma in the reaction stream. The voltage is sufficient to ignite and sustain the plasma in the reaction stream. The plasma produces a reaction that forms a product stream comprising reaction products. The dielectric tube comprises an inlet end configured and arranged to accept the first feed stream and the second feed stream, and the dielectric tube comprises an outlet end configured and arranged to discharge the product stream.

According to an embodiment, the second feed stream comprises a liquid and the reaction stream is a gas/liquid biphasic stream. According to an embodiment, the first (gaseous) feed stream comprises at least one of gaseous helium, gaseous argon, gaseous nitrogen, or combinations thereof. According to an embodiment, the first feed stream comprises at least one of gaseous helium, gaseous argon, or combinations thereof; the second feed stream comprises H₂O; and the reaction products in the product stream comprise H₂O₂. According to an embodiment, the reaction products in the product stream further comprise gaseous H₂ and the method further comprises a step c) removing the gaseous H₂ from the product stream. According to some embodiments, the concentration of reaction products in the product stream, such as H₂O₂ in water, of from 0.1 to 40 mM preferably from 1 to 40 mM, more preferably from 10 to 40 mM. The concentration of H₂O₂ in water in the product stream may be at least 0.1, 0.2, 0.3, 0.4, 0.5, 0.6, 0.7, 0.8, 1, 2, 3, 4, 5, 6, 7, 8, 9, 10, 15, 20 25, 30, 35, or at least 40 mM. The concentration of H₂O₂ in water in the product stream may be at most 45, 40, 35, 30, 35, 20, 15, 10, 9, 8, 7, 6, 5, 4, 3, 2, or at most 1 mM.

According to some embodiments, the carrier gas may be recovered from the outlet of the tubular reactor and recycled to the process stream of the tubular reactor. According to some embodiments, water (or other unreacted liquid feed) may be recovered from the product stream and recycled to the process stream of the tubular reactor.

According to another embodiment, the first feed stream comprises at least one of gaseous helium, gaseous argon, or a combination thereof; the second feed stream comprises liquid water and at least one liquid organic compound and; the reaction stream comprises a gas/liquid biphasic stream. According to some embodiments, the organic compound may be at least one of methylene blue, Congo red, polyfluoroalkyl substances (PFAS) or combinations thereof.

According to an embodiment, the first feed stream comprises gaseous helium, gaseous argon, or a combination thereof; and at least one gaseous hydrocarbon; the second feed stream comprises liquid water; the reaction stream comprises a gas/liquid biphasic stream; and the reaction products in the product stream comprise liquid oxygenated hydrocarbons and gaseous H₂. According to an embodiment, the gaseous hydrocarbon comprises at least one of methane, ethane, propane, butane, pentane, hexane; and/or isomers thereof; and/or mixtures thereof.

According to another embodiment, the first process stream comprises gaseous helium, gaseous argon, or a combination thereof; and gaseous O₂; the second process stream comprises at least one liquid organic compound; the reaction stream comprises a gas/liquid biphasic stream; and the reaction products in the product stream comprise liquid oxygenated organic compounds. For example, the liquid organic compound in the feed stream may be at least one of C6 to C30 hydrocarbons such as dodecane. The oxygenated organic products may be alcohols, carboxylic acids, and/or aldehydes; or combinations thereof. Non-limiting examples of oxygenated products are dodecanol, dodecanoic acid, or dodecanal.

### Reactions:

Reactions that may be carried out by use of the apparatus and method disclosed here include preparation of hydrogen peroxide from distilled water and an inert carrier gas such as He or Ar, as described in the Examples. Other reactions that may be carried out are partial or complete oxidation of liquid and/or gaseous hydrocarbons, and/or complete or partial degradation of organic compounds.

### Applied Electric Voltage:

The electric voltage may be alternating (AC) or direct (DC). Suitable voltages may be from 1 kV to 20 kV, preferably from 3 to 15 kV, more preferably from 5 to 10 kV (either DC or peak to peak AC). For example, the applied voltage may be at least 1 kV, 1.5, 2, 2.5, 3, 3.5, 4, 4.5, 5, 5.5, 6, 6.5, 7, 7.5, 8, 8.5, 9 or at least 9.5 kV (either DC, or AC peak-to-peak.) The applied voltage may be at most 20 kV, 19.5, 19, 18.5, 18, 17.5, 17, 16.5, 16, 15.5, 15, 14.5, 10, 9.5, 9, 8.5, 8, 7.5, 7, 6.5, 6, 5.5, 5, or at most 4.5 kV (either DC, or AC peak-to-peak.) The power may be from 0.1 to 4 W. For example, the applied power may be at least 0.1, 0.2, 0.3, 0.4, 0.5, 0.6, 0.7, 0.8, 0.9, 1, 1.5, 2, 2.5, 3 or at least 3.5 W. The applied power may be at most 4.0 W, 3.9, 3.8, 3.7, 3.5, 3.2, 3.0, 2.5, 2, 1.5, 1.25, 1, 0.9, 0.8, 0.7, 0.6, 0.5, 0.4, 0.3, 0.2, or at most 0.1 W.

A ratio of the voltage to the gap length may be at least about 1 kV/mm. According to some embodiments, the ratio of the voltage to the gap length may be at least about 0.1, 0.2, 0.3, 0.4, 0.5, 0.6, 0.8, 0.9, 1, 1.1, 1.2, 1.3, 1.4, 1.5, 1.6, 1.7, 1.8, 1.9, 2.0, 2.25, 2.5, 2.75, or at least about 3 kV/mm. According to some embodiments, the ratio of the voltage to the gap length may be at most about 3 kV/mm. According to some embodiments, the ratio of the voltage to the gap length may be at most about 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, or at most about 1.1 kV/mm.

According to some embodiments, energy yield of reaction product may be from 0.1 to 2 g/(kW-hr), preferably from 0.4 to 2 g/(kW-hr), more preferably from 0.4 to 2 g/(kW-hr). According to some embodiments, the energy yield of reaction product may be at least 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 3.25, 3.5, 3.75, 4.0, 4.25, 4.5, 4.75, 5.0, 5.25, 5.5, 5.75, 6.0, 6.25, 6.5, 6.75, 7.0, 7.25, 7.5, 7.75, 8.0, 8.25, 8.5, 8.75, 9.0, 9.25, 9.5, or at least about 9.75 g/(kW-hr). According to some embodiments, the yield of reaction product may be at most about 10, 9.9, 9.8, 9.7, 9.6, 9.5, 9.4, 9.3, 9.2, 9.1, 9.0, 8.9, 8.8, 8.7, 8.6, 8.5, 8.4, 8.3, 8.2, 8.1, 8.0, 7.9, 7.8, 7.6, 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.75, 4.5, 4.4, 4.3, 4.2, 4.1, 3.9, 3.8, 3.7, 3.6, 3.5, 3.4, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, or at most about 1.1 g/kW hr.

### Temperatures:

Suitable temperatures range from below room temperature to temperatures close to the boiling point of water at 1 atmosphere, for example, from 5° C. to 99° C., preferably from 15 to 70° C., more preferably from 20 to 40° C. The temperature of the reactor may be at least 5° C., or 10, 15, 20, 21, 22, 23, 24, 25, 26, 27, 28, 29, 30, 31, 32, 33, 34, 35, 36, 37, 38, 39, 40, 45, 50, 55, 60, 65, 70, 75, 80 or at least 90° C. The temperature of the reactor may be at most 99° C., 98, 97, 96, 95, 94, 93, 92, 91, 90, 88, 86, 84, 82, 80, 75, 70, 65, 60, 55, 50, 45, 40, 35, 30, 29, 28, 27, 26, 25, 24, 23, 22, 21, 20, or at most 15° C.

Flow rates:

The liquid (e.g. water) and gas (e.g. He) flow rates may be 0.2 and 320 mL/min, respectively, to provide a G:L ratio of 1600.

Liquid flow rates may be from 0.01 to 100 mL per minute, preferably from 0.02 to 10 mL/min, more preferably from 0.05 to 0.5 mL/min. The liquid flow rate may be at least 0.01, 0.05, 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, 60, 65, 70, 75, 80, 85, 90, or at least 95 mL per minute. The liquid flow rate may be at most 100 mL/minute, or 99, 98, 97, 96, 95, 94, 93, 92 91, 90 85, 80, 75, 70, 65, 60, 55, 50 45, 40, 35, 30, 35, 20 15, 10, 9.5 9.0 8.5, 8.0, 7.5, 7.0, 6.5, 6.0, 5.5, 5.0, 4.5, 4.0, 3.5, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1, 0 0.9, 0.8, 0.7, 0.6, 0.5, 0.4, 0.3, or at most 0.2 mL/min.

The gas flow rates may be from 5 mL to 1,000 mL per minute, preferably from 10 to 1,000 mL/min, more preferably from 10 to 700 mL/min. For example, the gas flow rate may be at least 5, 6, 7, 8, 9, 10, 20, 30, 40, 50, 60 70, 80, 90, 100, 125, 150, 175, 200, 225, 250, 275, 300, 310, 320, 330, 340, 350, 360, 370, 380, 390, 400, 410, 420, 430, 440, 450, 460, 470, 480, 490, 500, 525, 550, 575, 600, 650, 700, 750, 800, 900, 1000, 1250, 1500, 1750, 2000, 2500, 3000, 3500, 4000, 4500, 5000, 5500, 6000, 6500, 7000, 7500, 8000, 8500, 9000, or at least 9500 mL/min. The gas flow rates may be at most 10,000 mL/min or 9900, 9800, 9700, 9600, 9500, 9400, 9300, 9200, 9100, 9000, 8900, 8800, 8700, 8600, 8500, 8400, 8300, 8200, 8100, 8000, 7900, 7800, 7700, 7600, 7500, 7400, 7300, 7200, 7100, 7000, 6900, 6800, 6700, 6600, 6500, 6400, 6300, 6200, 6100, 6000, 5900, 5800, 5700, 5600, 5500, 5400, 5300, 5200, 5100, 5000, 4900, 4800, 4700, 4600, 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 1700, 1600, 1500, 1400, 1300, 1200, 1100, 1000, 900, 800, 700, 600, 500, 400, 300, 200, 100, 90, 80, 70, 60, 50 40, 30, or at most 20 mL/min.

The ratio of the gas to liquid flow rate (G:L) on a volume basis may be from 20 to 5,000, on a volumetric basis, preferably from 100 to 1600, more preferably from 320 to 3200.

### Applications:

The plasma reactor and process disclosed herein provide a point-of-use peroxide production from inert gas and de-ionized water and also provides chemical and biological pollution abatement in wastewater treatment. The reactor and process may also be used to transform waste plastic breakdown derivatives into value-added products as well as to provide value from biomass via aqueous phase oxidative transformations and transformation of biomass into valuable oxygenated products such as alcohols and acids.

### EXAMPLES

Experiments to produce hydrogen peroxide were run in the reactor and reactor system shown in FIGS. 1-5. Computational simulations were also run.

The parameters for the simulations and the experimental set-up are as follows:

A syringe pump (NE-100, SyringePump.com) provided the water (Milli-Q) stream to a Tee junction (IDEX PEEK Low-Pressure Tee Assembly, 1/16″ OD, 0.020″ through-hole) where it was mixed with helium (He) gas (99.999%, Keen Compressed Gas) regulated using a mass flow controller (Brooks GF40). The biphasic stream exiting the Tee junction flowed into a tubular microreactor (IDEX PFA tubing, 1/16″ OD, 0.03″ ID) wrapped around a stainless-steel rod (diameter=4.8 mm) serving as the ground electrode of the electrical circuit. A copper foil wrapped the coiled microreactor, which was connected to a sinusoidal AC power supply (PVM500), served as the high-voltage electrode. The coaxial assembly is shown in FIGS. 1A and 1B. The outer electrode length was changed to vary the discharge region and, in turn, the exposure time of the two-phase stream to the plasma could be varied. The discharge frequency was set to 22.5 kHz, while the peak-to-peak applied voltage varied between 2 and 8 kV. A picture of the pure He plasma (Nikon D3300) is shown in FIG. 3C, where a transparent ITO (indium tin oxide) electrode was employed. The entire experimental setup is represented in FIG. 1.

The reactor wall temperature was varied using a silicone rubber heating tape (OMEGA) positioned at the two ends of the stainless-steel rod. A thermocouple placed on the tubular reactor wall provided feedback control for heating. Although the temperature of the tube in direct contact with the heated rod was inaccessible, the fast heat transfer in a microreactor ensured uniform temperature throughout the reactor wall. The reactor temperature spanned from room temperature (i.e., 21° C.) to 50° C.

The hydrogen peroxide concentration was analyzed through the titanium sulfate method in a VIS spectrophotometer (Hach DR 3900) at λ=407 nm. A titanium (IV) oxy sulfate acid solution (Sigma Aldrich) was diluted with water 1:1 and used for the colorometric analysis. A 1 mL sample of this solution was added into quartz cuvette together with 2 mL of the diluted sample drawn from the outlet of the reactor. The absorbance of the yellow color produced by mixing the two liquids was recorded with the VIS spectrometer.

Optical emission spectroscopy (OES) was performed in the microreactor running with the biphasic mixture of He (or Ar) and liquid water or water-methylene blue solution. A slit was open through the outer electrode to visually access the tubular microreactor during plasma ignition. The plasma emission was captured through an optical fiber (400 μm) adjusted to a collimating lens. The wideband emission spectrum in the range 200-900 nm was acquired by the AvaSpec-UL4096CL-EVO spectrometer and processed with dedicated Avasoft software.

All experiments were run in triplicate and as indicated in the error bars in the graphs.

The capacitance of the DBD reactor shown in FIGS. 1-5 was measured via a digital LCR tester (SZBJ). The voltage and current were recorded using an oscilloscope (Tektronix MDO34) through a high voltage probe (Tektronix P601SA) and a current monitor (Pearson 2100). The power (P) was calculated from the integration of time (t) of the voltage (V) and current (i) over a total time period (T) according to equations 1 and 2.

$$P = \frac{1}{T} \int V ( t ) \times i ( t ) dt \qquad ( 1 )$$

The energy yield E, g (kWh)⁻¹ is

$$E = \frac{c \times {Q}_{L}}{P} \qquad ( 2 )$$

where c is the H₂O₂ concentration in g/L, Q is volumetric flow rate (L/hr), and P is the power delivered to the system. The energy yield expression in (2) is used to describe the plasma-assisted production of H₂O₂, thus it represents a valuable comparison metric among different reactor configurations. In equation 2, the calculated power refers to the power consumed at the load and not the actual power from the grid. Equation 3 shows that the specific surface area SSA and the volume of the slugs Vₛ are obtained from the surface area SAₛ and droplets as calculated in the CFD simulations. The length of the slugs was also obtained from the CDF modeling.

$$SSA = \frac{{SA}_{S}}{{V}_{S}} \qquad ( 3 )$$

### IR Thermography

The wall temperature of the tubular reactor was monitored right outside the plasma zone with a thermocouple which triggered the temperature controller connected to the heating tape wrapped around the stainless-steel rod. In addition, thermal images were recorded with an IR camera (Optris Xi 400) to confirm the accuracy of the thermocouple measurement.

H₂O₂ Production.

Examples 1-7 are related to an exemplary use of the inventive reactor to produce H₂O₂ from water. Examples 1-6 all used He as the carrier gas and Example 7 demonstrates that Ar is also a suitable carrier gas for production of H₂O₂ from water.

H₂O₂ is mainly generated through the recombination of ·OH radicals in the gas phase and at the gas-liquid interface, followed by diffusion of H₂O₂ into the liquid bulk. In a simple reaction pathway, ·OH radicals are initially formed through the dissociation of water vapors in the plasma zone (equation R1). That process is initiated by electron impact dissociation reaction or interaction of water molecules with other highly energetic species like He⁺, He²⁺, and He*. Optical emission spectroscopy (OES) measurements showed that the discharge is dominated by the several He emission bands; some transitions (i.e., at 388 and 501 nm) lead directly to highly energetic metastable states whose contribution to the gas phase chemistry is significant. The radical recombination either at the gas phase (equation R2) or at the gas-liquid interface (equation R3) results in an H₂O₂ formation that diffuses into the liquid, with the bulk water serving as an absorbent (reactive absorption scheme) that protects the H₂O₂ from dissociating in the plasma region. The main ·OH depletion reaction is the recombination with ·H to water (equation R4). The overall reaction (equation R5) entails the formation of H₂O₂ and H₂ from H₂O.

H₂O(g)→·OH+·H (R1)

·OH(g)+·OH(g)→H₂O₂(g)→H₂O₂(aq) (R2)

·OH(aq)+·OH(aq)→H₂O₂(aq) (R3)

·OH+·H→H₂O (R4)

2H₂O→H₂O₂+H₂ (R5)

Several parameters can potentially affect the process output. Increasing the applied voltage leads to higher power input and enhanced electron density and electron temperature as well as higher water vapor pressure (due to the heating effect), all leading to an enhanced water dissociation rate. A higher interfacial area intensifies not only the liquid-phase ·OH radical recombination reaction to H₂O₂ but also the mass transfer of gas-phase generated H₂O₂ to the liquid phase. The residence time of the liquid phase (i.e., water) in the plasma zone is also critical for the absorption (and accumulation) of H₂O₂ in the liquid and the evaporation of water. Both interfacial area and residence time are directly governed by the gas-to-liquid flow rate ratio (G:L) and the total flow rate of the biphasic mixture. Finally, external heating of the system also affects the process. The present coaxial DBD microreactor design allows the fine-tuning of all these parameters. Their effect on H₂O₂ formation is discussed in the following Examples.

### Example 1: Computational Modeling

CFD simulations of two-phase flow were conducted using the single-field incompressible Navier-Stokes equations modeled with the volume-of-fluid (VOF) method. The VOF model is a surface-tracking method to resolve sharp interfaces between gas and liquid and gives good agreement between simulations and experiments of two-phase flow. The detailed governing equations of the VOF are described in Mariotti, D. et al. J. Phys. D: Appl. Phys. 2010, 43, 323001; Hirt, C. W. et al., J. Comput. Phys. 1981, 39, 201-225; Desir, P. et al., React. Chem. Eng. 2020, 5, 39-50; Chen, T. Y. et al., Ind. Eng. Chem. Res. 2021, 3723; and Hoang, D. A. at al., Comput. Fluids 2013, 86, 28-36.

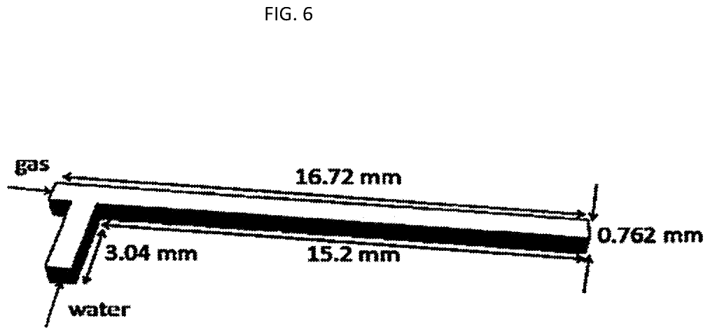

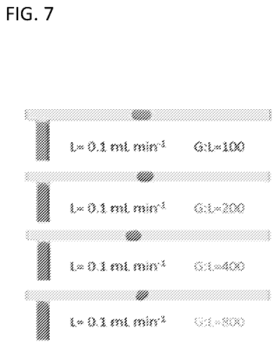

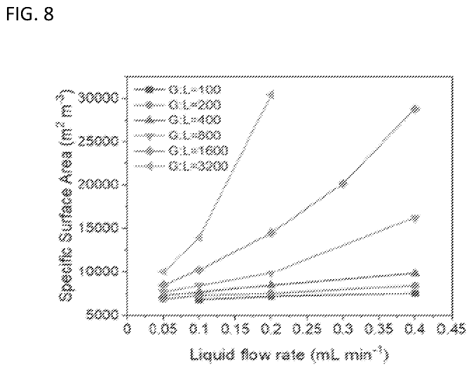

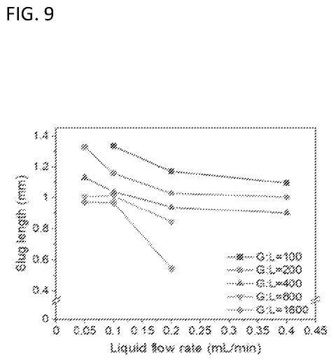

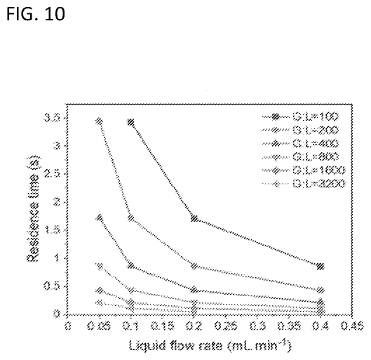

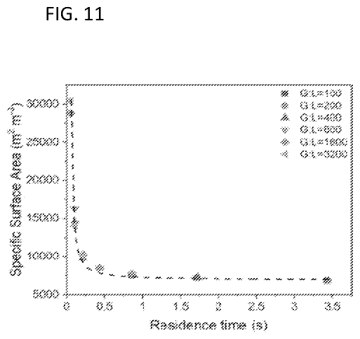

These equations were solved with the finite-volume based computational fluid dynamic (CFD toolbox, OpenFOAM, Yang, L. et al. Chem. Eng. Sci. 2017, 169, 106-116.) The simulation mesh was established as a 3D T-shape micromixer as shown in FIG. 6, which shares the same geometric parameters and flow conditions with Examples 1-7. The specific surface area was calculated using the surface area and the volume of the slugs and droplets obtained from the CFD simulations. Specifically, these properties were evaluated from the isocontour at 0.9 of water volume fraction to isolate the slug and droplet using the Paraview post-processing tool. The flow configuration dimensions are shown in FIG. 6. As seen in FIG. 6, water and helium gas enter the reactor. The geometry implemented in the volume-of-fluid (VOF) simulation is shown in FIG. 6. The channel size is 0.03 inch (0.762 mm). A total of 1,672,000 cells within the simulation domain were used, and the flow pattern and slug size are independent of discretization. The dispersed phase, water, flows into the T-mixer from one inlet, while the continuous gas phase flows into the Tmixer from the other orthogonal inlet and mixes with the water. The maximum Courant number is set to 0.25 to control the time step without reducing the accuracy and quality of the simulation. Zero gradient for the pressure and no-slip boundary condition for the velocity are implemented at the microchannel wall, and the contact angle is 180°. At the inlet, a zero pressure gradient and a constant velocity are used as boundary conditions. At the outlet, the velocity and volume fraction are set to be zero-gradient, and the pressure to be atmospheric. The slug size at various carrier gas to liquid flow volumetric rate ratios (G:L) as calculated by the CFD analysis are shown in FIG. 7. FIG. 8 shows the CFD calculated specific surface area of the gas/liquid interface, where the plasma is formed as a function of liquid flow rate. FIG. 9 shows the calculated slug length as a function of liquid flow rate. FIG. 10 shows the CFD calculated residence time as function of in the applied voltage field at various G:L ratios for an electrode length of 12 cm. FIG. 11 shows the CFD calculated specific surface area of the gas/liquid interface, where the plasma is formed as a function of the residence time at various G:L ratios.

### Example 2: Effect of Reactor Geometry

The modular design of the helical microreactor allows the varying of the tube length and plasma zone through the elongation of the outer high-voltage electrode. The interelectrode distance remains constant as defined by the outer diameter of the tubular reactor (i.e., 1/16″). A constant sinusoidal voltage (8 kV, peak-to-peak) was applied while varying the length of the outer electrode. The liquid (water) and gas (He) flow rates were 0.2 and 320 mL/min, respectively, to provide G:L ratio of 1600. A longer electrode creates a longer residence time of the biphasic mixture in the plasma zone. The larger plasma region when upsizing the electrode length corresponds to increased reactor capacitance and power dissipation. The capacitance (C) of a cylindrical capacitor varies with the inner (a) and outer (b) diameters and its length (L), according to Equation 4 (co is the permittivity of free space and is constant), and is expected to scale linearly with the electrode length (L). It follows that the current (i) and the power are also linearly related to the electrode length as per Equation 1 (above) and 5.

$$C = \frac{2 {πε}_{0} L}{ln ( \frac{b}{a} )} \qquad ( 4 )$$

$$I ( t ) = D \frac{dv ( t )}{dt} \qquad ( 5 )$$

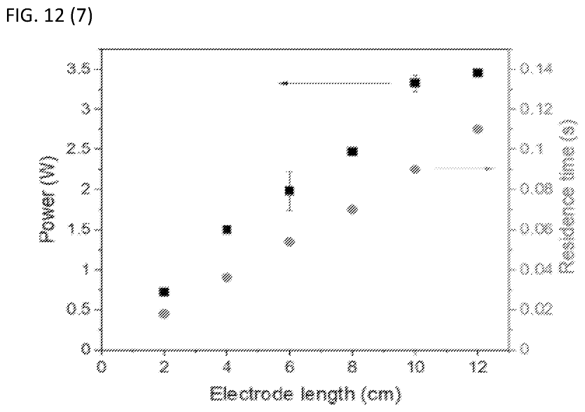

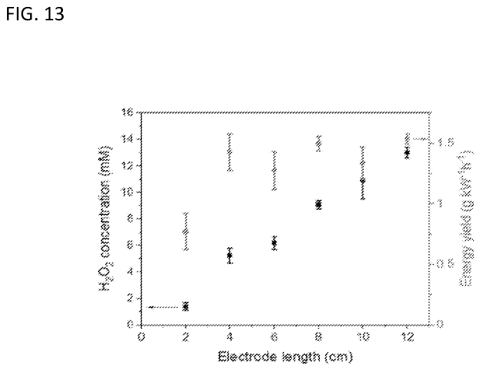

The experimental results of varying the outer electrode length, i.e., the length of the helical reactor that was subjected to the voltage are shown in FIGS. 12 and 13. As noted above, the electrode length was 12 cm, the liquid (water) and gas (He) flow rates were 0.2 and 320 mL/min, respectively, to provide G:L ratio of 1600. A 1/16″ diameter PFA tube was wrapped helically around the inner stainless-steel electrode.

Based on the CFD simulations, and the experiments, several parameters are expected to affect the process output. Increasing the applied voltage leads to higher power input and enhanced electron density and electron temperature as well as higher water vapor pressure (due to the heating effect), all leading to an enhanced water dissociation rate. A higher interfacial area intensifies not only the liquid-phase ·OH radical recombination reaction to H₂O₂ but also the mass transfer of gas-phase generated H₂O₂ to the liquid phase. The residence time of the liquid phase (i.e., water) in the plasma zone is also critical for the absorption (and accumulation) of H₂O₂ in the liquid and the evaporation of water. Both interfacial area and residence time are directly governed by the gas-to-liquid flow rate ratio (G:L) and the total flow rate of the biphasic mixture. Finally, external heating of the system also affects the process. The coaxial DBD microreactor design allows the fine-tuning of all these parameters.

The measured capacitances at different electrode lengths matched the theoretical trend (Eq 4). The values for each experimental condition are reported in Table 1 together with the measured dissipated power and the residence time of the mixture in the plasma region, which affect the production of H₂O₂ as displayed in FIGS. 12 and 13.

FIG. 12 shows that an extended plasma zone results in a higher residence time but consumes higher power. The increased power and residence time attained by extending the electrode length increases the H₂O₂ concentration. The energy yield for different electrode lengths is relatively constant (FIG. 13). Importantly, these results underscore that a one-dimensional scale-up approach provides constant energy efficiency while controlling the residence time. Table 1 shows the effect of the electrode length on capacitance, residence time and power.

TABLE 1
Effect of electrode length on various parameters at gas and liquid
flowrates of 320 and 0.2 mL/min, respectively (G:L = 1600)

| Electrode | | Residence | |
|---|---|---|---|
| length (cm) | Capacitance (pF) | time (s) | Power (W) |
| 2 | 5.8 | 0.018 | 0.73 |
| 4 | 10 | 0.036 | 1.5 |
| 6 | 13.3 | 0.054 | 1.98 |
| 8 | 17.6 | 0.07 | 2.47 |
| 10 | 19.4 | 0.09 | 3.33 |
| 12 | 23.3 | 0.11 | 3.46 |

### Example 3: Effect of Applied Voltage

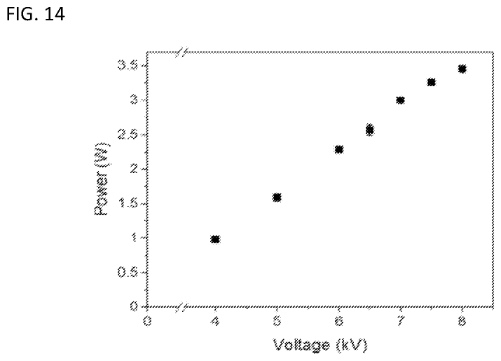

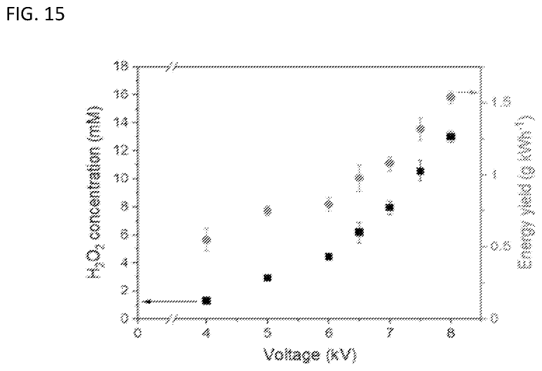

Like most atmospheric pressure plasma reactors, the maximum applied voltage is limited by the emergence of instabilities. The linear scale-up enables increased power while maintaining stability. FIG. 14 displays the delivered power at different applied voltages. Plasma was ignited at 4 kV. Low applied voltages provided low energy consumption and H₂O₂ production as shown in FIGS. 14 and 15, although a nonlinear surge of energy yield was observed with increasing applied voltage. FIGS. 12-15 demonstrate that operating the reactor at the voltage upper limit provided the most productive and energy efficient strategy. Due to the narrow window of applied voltages, extending the plasma zone using longer electrodes is a viable way to increase the delivered power and residence time.

### Example 4: Effect of Flow Rate

The flow rate of each stream and the gas-to-liquid ratio (G:L) affected the residence time in the plasma zone and the specific surface (interfacial) area. The microreactor allowed the tuning of the interfacial area of the liquid slugs produced in the reactor. The CFD calculations were performed for the increasing G:L ratio to calculate the slug size. The results are shown in FIG. 7, as mentioned above. Small and more irregular liquid slugs/droplets form at high gas flow rates for a given liquid flow rate, resulting in a higher interfacial area as shown in FIG. 8. At very high G:L ratios (i.e., 1600 and higher), the flow regime transitions into a droplet type as the length of the slugs is lower than the internal diameter of the tubular reactor (i.e., 0.76 mm), as shown in FIG. 9. Due to the irregular nature of the droplets, there is not a single characteristic length at very high G:L values.

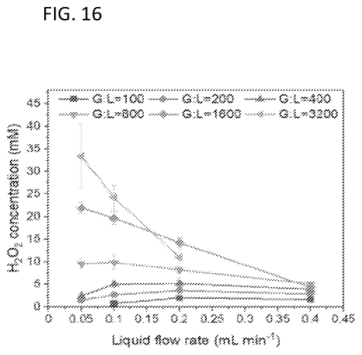

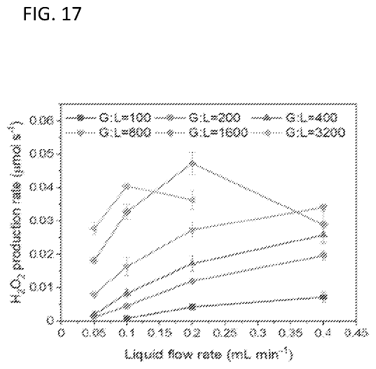

The high specific surface area favored mass transfer between phases. Higher gas flow rates assisted in sustaining the plasma and provide a higher gas-liquid interfacial area but reduced the residence time for H₂O₂ production. The residence time of the biphasic mixture in the plasma was calculated from the constant plasma volume (at an electrode length equal to 12 cm corresponding to a tube length of 1.3 m) and the varying input values of the gas and liquid flow rates. FIG. 8 shows the calculated relationship between the gas-to-liquid ratio and the residence time of the reactive mixture. The flow rate conditions yielding higher specific surface area (high G:L ratio as in FIG. 9) also lead to low residence times (FIG. 10), and a trade-off between specific surface area and residence time occurs (FIG. 11). The effect of specific surface area and residence time is reflected in the measured H₂O₂ concentration (FIGS. 16, 17, and 18). High G:L ratios increase the interfacial area and the product concentration. As the liquid flow rate increases, the residence time decreases, resulting in more dilute solutions except for low G:L ratios, where a weak maximum occurs due to a trade-off of specific surface area and residence time. Similarly, the H₂O₂ production rate (ρ) increases with increasing the liquid flow rate (QL) at low to moderate G:L ratios and exhibits nonmonotonic behavior at high G:L ratios. A compensation effect is observed where the concentration (c) reaches the highest values at low liquid flow rates (FIG. 16) and the production rate (ρ) peaks at intermediate to high flow rates (FIG. 17).

$$P = c \cdot {Q}_{L} \qquad ( 6 )$$

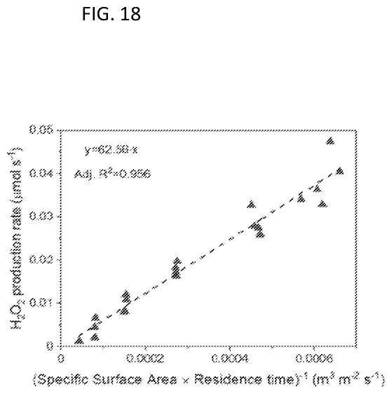

The strong dependence of the H₂O₂ concentration and production rate on the hydrodynamic parameters is shown in FIG. 17. The correlation between H₂O₂ production rate (ρ), the residence time (T), and the specific surface area (SSA) is quantified via fitting the experimental data (FIG. 18), resulting in Equation 7 (where p is in μmol s⁻¹, T is in s, and SSA is in m²/m³). Note that the residence time and specific surface area are correlated as shown in FIG. 11.

$$P = p = 62.56 {( SSA \cdot T )}^{- 1} \qquad ( 7 )$$

Within the operating window studied here, the maximum productivity of 0.05 μmol s⁻¹ was achieved with liquid and gas flow rates equal to 0.2 and 320 mL min⁻¹, respectively. A possible way to further enhance the H₂O₂ concentration and, in turn, the production rate, would be to operate the reactor with high gas and liquid flow rates and extend the reactor length (i.e., the length of the tubular reactor wrapped helically around the inner electrode and the length of the outer electrode) to provide sufficient residence time for reactive absorption. The feasibility of increasing the residence time by elongating the reactor while maintaining the same flow pattern has already been highlighted in FIG. 13.

### Example 5: Insights into the H₂O₂ Formation Pathway

The ·OH radicals produced via water dissociation in the gas phase are deemed responsible for the generation of H₂O₂ in the gas bulk and at the gas-liquid interface via radical recombination. A radical scavenger (DMSO) in the liquid feed can suppress the interfacial contribution by consuming ·OH radicals, forming formaldehyde and thus, it can provide insights into the role of interfacial phenomena. Specifically, different concentrations of DMSO were deployed in the water feed at varying gas-to-liquid flow rate ratios (G:L). G:L to delineate the effects of the specific surface area of the slugs/droplets and the mass transfer between phases. Due to the dilute nature of DMSO, its effect is mainly limited to radical scavenging.

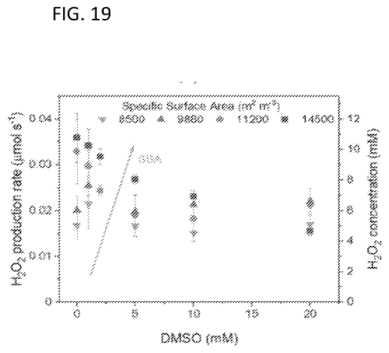

FIG. 19 shows that DMSO quenches ·OH radicals only for high specific surface areas (high G:L). Even high DMSO concentrations (i.e., 20 mM) are insufficient to suppress H₂O₂ completely. The results indicate that at lower interfacial areas, the H₂O₂ forms in the gas phase and absorbs in the liquid. The ·OH radical recombination path at the gas-liquid interface is significant only at high specific surface areas and can double the H₂O₂ production almost proportionally to the surface area. Extensive gas-phase recombination of ·OH has also been observed in another microfluidic device with a large gas volumetric fraction. A high interfacial area is beneficial for water evaporation (the reactant) and H₂O₂ absorption product protection from dissociation) and can also modify the plasma. The results demonstrate that radical interfacial recombination enhances productivity.

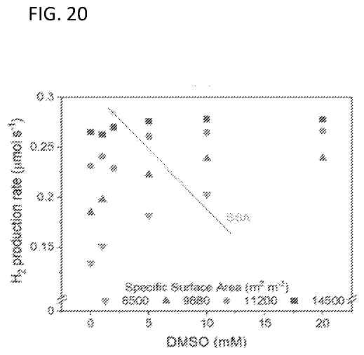

High G:L ratios increases the H₂ gas production from water dissociation, as shown in FIG. 20, almost proportionally to the increased surface area. Interestingly, DMSO increased the H₂ production by as much as twofold, and this effect was more pronounced for low interfacial areas. Such behavior can be attributed to the complex gas-liquid interaction chemistry responsible for H₂ formation, which may be also affected by the DMSO presence in the liquid water.

### Example 6: Effect of Temperature

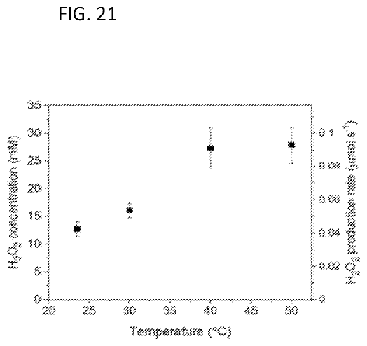

The inventive microreactor promotes rapid heat transfer from an external heating source. A temperature increase can affect the gas-phase chemistry in multiple ways: (a) increasing water vapor pressure leading to higher water concentration in the plasma, (b) changing electron energy and density in the discharge, and (c) altering kinetics among heavy species. Furthermore, a temperature increase could also favor the diffusion of gas-generated H₂O₂ as well as the interfacial ·OH radical recombination toward H₂O₂. The pivotal role of the gas-phase production of H₂O₂ has been shown in Example 5; hence, a water vapor increase is expected to prove beneficial as reported in previous studies. However, there is an upper-temperature limit beyond which the high H₂O content in the discharge causes instabilities in the plasma. Furthermore, H₂O₂ undergoes decomposition at high temperatures to form water and oxygen gas. FIG. 21 depicts the trend of the H₂O₂ concentration with the microreactor temperature at a fixed G:L ratio of 1600. Interestingly, an increase in the reactor wall temperature correlates with rising H₂O₂ concentration. The beneficial effect of increasing temperature on the H₂O₂ concentration indicates that the overall production rate (in gas phase and gas-liquid interface) outweighs the decomposition rate in the liquid. The H₂O₂ thermal decomposition follows first-order kinetics and is chiefly promoted at elevated temperatures (i.e., above 100° C.). Accordingly, decomposition is expected to be limited in this reactor configuration due to the relatively low temperatures applied (max 50° C.) as well as the short residence time. A maximum production rate of 0.1 μmol s⁻¹, associated with an H₂O₂ concentration of >25 mM, was recorded at a reactor wall temperature of 50° C. Hence, an energy yield of 4 g (kWh)⁻¹ is reached even with a low liquid flow rate (i.e., 0.2 mL min⁻¹, G:L=1600). Moreover, molecular H₂ is produced when two water molecules combine, and from the highest value displayed in FIG. 20, it can be deduced that 0.16 g of H₂ per liter of solution gets produced during the process. The energy-rich H₂ generated could be employed in a fuel cell to supply part of the energy spent in the process. As a first approximation, the integration of a hydrogen fuel cell (with an energy efficiency of 70%) in the system could save about 43 KJ g⁻¹ of liquid H₂O₂.

### Example 7: Comparison of Argon and Helium as Carrier Gases for Production of H₂O₂ from Distilled Water

A scaled-up reactor and system such as used in Examples 2-6 were used to produce hydrogen peroxide from distilled water, but using argon, rather than helium, as the carrier gas. The scaled-up reactor had a tube length of 3.82 m and the outer electrode was 15 cm long. The applied voltage was varied from 6 to 9 kV (peak-to-peak).

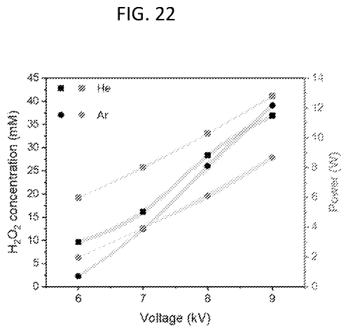

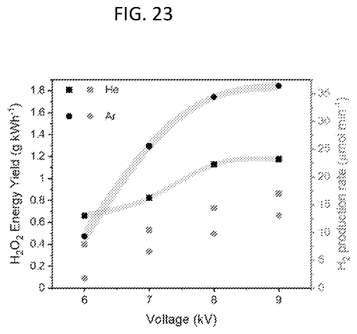

The results are shown in FIGS. 22 and 23. FIG. 22 shows the H₂O₂ concentration and the dissipated power as a function of the applied voltage for both Ar and He as carrier gasses. FIG. 23 shows the H₂O₂ energy yield and hydrogen gas production rate as a function of applied voltage. The experiments were done at room temperature (20-30° C.) and the G:L ratio in terms of volumetric flow rates was 1700. The results demonstrate that argon plasma enables H₂O₂ concentrations comparable to helium (at high applied voltage), while dissipating less power. Thus, a higher energy yield of H₂O₂ is attained for Ar compared to using He as the carrier gas. Therefore, replacing He with less costly and more abundant Ar could greatly benefit the economics of the electrified process. The results also show that hydrogen production in Ar plasma is in the same range as He, albeit slightly lower. Hence, further energy saving could be achieved by using H₂ as fuel for the electrical energy source.

### Example 8: Decolorization of an Organic Pollutant

The same microreactor as was used in Examples 7, using Ar as the carrier gas was used to decolorize an aqueous methylene blue solution. This is model compound and system to demonstrate the efficacy of the present reactor and system to treat wastewater containing organic chemicals for pollution abatement. Three different initial concentrations (C₀) of methylene blue were studied, 10, 100, and 300 mg/L. The applied voltage was varied from 6 to 9 kV at a G:L ratio of 1700 on a volume basis. The experiments were done at the room temperature (20-30° C.).

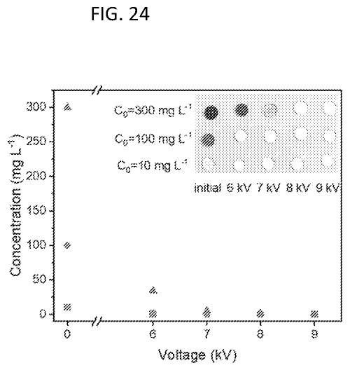

The results are shown in FIG. 24. The color change is represented in the upper right of FIG. 24, where the darker dots represent higher color intensity for the three different initial methylene blue concentrations of 10, 100, and 300 mg/L. As can be seen in the FIG. 24, complete decolorization of methylene blue can be attained in the microreactor with Ar plasma. These results demonstrate that water streams with high concentrations of organic contaminants can be treated in a continuous fashion using the present reactor. This case-study shows the potential of the modular microreactor in treating wastewater streams for pollutant abatement.

1. A reactor assembly for igniting and sustaining a plasma comprising:
an elongated cylindrical inner electrode;
a dielectric tube arranged helically around the elongated cylindrical inner electrode to form a helical reactor, the dielectric tube comprising an inlet end and an outlet end;
an annular outer electrode arranged around at least a portion of the exterior of the helical reactor such that the dielectric tube is disposed between the elongated cylindrical inner electrode and the annular outer electrode;
a power source configured to provide a voltage across the elongated cylindrical inner electrode and the annular outer electrode;
the reactor assembly configured to receive a flow of a process stream comprising at least a gas via the inlet end of the dielectric tube while the voltage is applied across the elongated cylindrical inner electrode and the annular outer electrode in an amount sufficient to cause at least a portion of the flow of the process stream in the dielectric tube exposed to the voltage to ignite and sustain the plasma.

2. The reactor assembly of claim 1, wherein the helical reactor contacts the elongated cylindrical inner electrode.

3. The reactor assembly of claim 2, wherein the helical reactor contacts an inner surface of the annular outer electrode.

4. The reactor assembly of claim 1, wherein a gap having a gap length separates the elongated cylindrical inner electrode and an interior surface of the annular outer electrode, and wherein a ratio of the voltage to the gap length is at least about 1 kV/mm.

5. The reactor assembly of claim 1, wherein the dielectric tube has an outer diameter in a range of 1.5 mm to 3.5 mm; and an inner diameter in a range of 0.75 mm to 1.5 mm.

6. The reactor assembly of claim 1, wherein the elongated cylindrical inner electrode has a diameter in a range of 4 mm to 20 mm.

7. The reactor assembly of claim 1, wherein the dielectric tube comprises at least one of silicon dioxide (silica glass); boron trioxide and silicon dioxide (borosilicate glass); perfluoroalkoxyalkane; polytetrafluoroethylene; or combinations thereof.

8. The reactor assembly of claim 1, wherein the elongated cylindrical inner electrode comprises at least one of stainless steel, steel, aluminum, copper, or combinations thereof.

9. The reactor assembly of claim 1, wherein the annular outer electrode comprises at least one of stainless steel, steel, aluminum, copper, or combinations thereof.

10. The reactor assembly of claim 1, wherein the power source supplies a pulsed voltage between the elongated cylindrical inner electrode and the annular outer electrode.

11. The reactor assembly of claim 1, wherein the power source supplies a D.C. voltage between the elongated cylindrical inner electrode and the annular outer electrode.

12. The reactor assembly of claim 1, wherein the power source supplies an A.C. current between the elongated cylindrical inner electrode and the annular outer electrode.

13. A method of performing a reaction, comprising:
a) contacting a first feed stream comprising at least a gas with a second feed stream to provide a reaction stream;
wherein:
the contacting takes place in a dielectric tube arranged helically around an elongated cylindrical inner electrode to form a helical reactor, wherein an annular outer electrode is arranged around at least a portion of an exterior of the helical reactor such that the dielectric tube is disposed between the elongated cylindrical inner electrode and the annular outer electrode; and
b) applying a voltage across the annular outer electrode and the inner elongated cylindrical electrode to ignite and sustain a plasma in the reaction stream,
wherein:
the voltage is sufficient to ignite and sustain the plasma in the reaction stream;
the plasma produces a reaction that forms a product stream comprising reaction products; and
the dielectric tube comprises an inlet end configured to accept the first feed stream and the second feed stream, and the dielectric tube comprises an outlet end configured to discharge the product stream.

14. The method of claim 13, wherein the second feed stream comprises a liquid and the reaction stream is a gas/liquid biphasic stream.

15. The method of claim 13, wherein the first feed stream comprises at least one of gaseous helium, gaseous argon, gaseous nitrogen, or combinations thereof.

16. The method of claim 13, wherein:
the first feed stream comprises at least one of gaseous helium, gaseous argon, or combinations thereof;
the second feed stream comprises H₂O; and
the reaction products in the product stream comprise H₂O₂.

17. The method of claim 16, wherein the reaction products in the product stream further comprise gaseous H₂ and the method further comprises a step c) removing the gaseous H₂ from the product stream.

18. The method of claim 13, wherein:
the first feed stream comprises at least one of gaseous helium, gaseous argon, or a combination thereof;
the second feed stream comprises liquid water and at least one liquid organic compound and;
the reaction stream comprises a gas/liquid biphasic stream.

19. The method of claim 13, wherein:
the first feed stream comprises gaseous helium, gaseous argon, or a combination thereof; and at least one gaseous hydrocarbon;
the second feed stream comprises liquid water;
the reaction stream comprises a gas/liquid biphasic stream; and
the reaction products in the product stream comprise liquid oxygenated hydrocarbons and gaseous H₂.

20. The method of claim 13, wherein:
the first process stream comprises gaseous helium, gaseous argon, or a combination thereof; and gaseous O₂;
the second process stream comprises at least one liquid organic compound;
the reaction stream comprises a gas/liquid biphasic stream; and
the reaction products in the product stream comprise liquid oxygenated organic compounds.

21. A method of performing a reaction, comprising the steps of:
a) providing the reactor assembly of claim 1;
b) receiving the process stream in the reactor assembly via the inlet end of the dielectric tube, the process stream comprising a first feed stream comprising at least a gas and a second feed stream;
c) contacting the first feed stream with the second feed stream;
d) applying the voltage across the annular outer electrode and the inner elongated cylindrical electrode to ignite and sustain the plasma in the process stream;
e) the plasma causing a reaction that forms a product stream comprising reaction products; and
f) discharging the product stream from the outlet end of the dielectric tube.
